(19) United States
(12) Patent Application Publication
(10) Pub. No.: US 2020/0262647 A1
(43) Pub. Date: Aug. 20, 2020

(54) Infinity Bag

(71) Applicant: Logan Kent Richards, Wildwood, MO (US)

(72) Inventor: Logan Kent Richards, Wildwood, MO (US)

(21) Appl. No.: 16/236,616

(22) Filed: Feb. 19, 2019

(51) Int. Cl. B65F 1/06; B65F 1/00; B65D 33/00

(52) U.S. Cl. CPC B65F 1/062; B65F 2220/12; B65D 33/002; B65F 1/0006

(57) ABSTRACT

The purpose of the infinity bag invention is to evolve the process of single use trash bags. By evolving this process, consumers will have a more convenient way to take out the trash, while saving time and hassle. The Infinity Bag is uniquely folded, rolled (2,2′) and packaged and uses adhesive technology (4,4′) to connect single trash bags together in a pre nested order creating the continuous connection. Pre nested bags allow the consumer to be provided a new bag instantly, when a full trash bag is removed. Removing the time and hassle of locating the box or roll and putting a new trash bag in each use. Other benefits for the consumer include the easy ability of double bagging heavy loads of trash. When a full bag is lifted, a new bag is instantly provided, which can be detached and placed around the full trash bag.

### TECHNICAL FIELD

Plastic bags/Trash bags

### BACKGROUND ART

Single use trash bags currently exist in a box or on a roll. Getting the next bag requires a separate action of extracting from the box or roll.

### SUMMARY OF THE INVENTION

The Infinity Bag will revolutionize the single use trash bag by removing the hassle of putting in a new trash bag after taking a full one out. While also providing a simple and efficient way to double bag heavy loads of trash. The Infinity Bag's unique pre-nested design allows for a continuous flow of bags right from the trash can automatically supplying the next bag to the user.

Each trash bag is pre-nested into the one below it, connected with adhesive technology (double sided tape or perforation). The nested bags are set within each other, allowing the bottom bag to be lifted up when the current bag is taken out.

Trash bags are uniquely folded and rolled to properly produce the next trash bag. After bags are connected with adhesive technology, any inside air is compressed to allow easier folding and rolling. Both sides of the bags are folded inwards 8 inches and then tightly rolled from the last bag to the first.

The bags are placed on the bottom of the trash can, each time a new bag is pulled up the next bag is automatically brought up; allowing continual bags to be produced. The bags on the bottom of the trash bin are heavy enough to stay down, while new bags are being pulled up.

When pulling the current trash bag out all that is needed is a light tug, while holding on to attached bag. The bags will detach allowing the consumer to place their full bag to the side and position the newly provided bag around their trash bin.

To double bag the consumer will simply pull the existing full bag out, grab the edges of the newly provided bag and with a small tug the full bag will fall into new bottom bag. The consumer will then repeat the beginning steps by lifting the doubled trash bag, perform a small tug while holding on to the next provided bag, sit the doubled bag to the side and place the newly provided bag around their trash bin.

### BRIEF DESCRIPTION OF THE DRAWINGS

Adhesive technology 4,4′: Double sided tape or perforation. Adhesion technology has been tested, providing evidence of success.

FIG. 1: A view of a trash bin, and the roll of Infinity bags at the bottom.

FIG. 2, 3, 4: First bag is lifted up and placed over bin.

FIG. 5: Full trash bag edges are taken off of the trash bin.

FIG. 6: Full trash bag is lifted up, bags unroll bringing the attached bag up

FIG. 7: Full trash bag is pulled out of the trash bin, with the below bag still attached. With a light tug the below bag detaches.

FIGS. 8 & 9: Newly provided bag is placed around the edges of the trash bin.

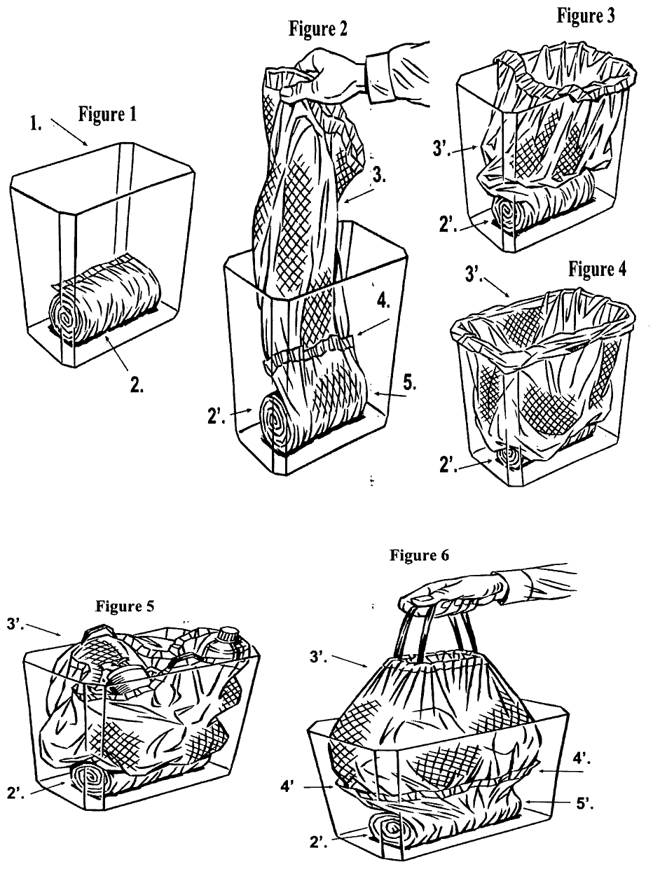

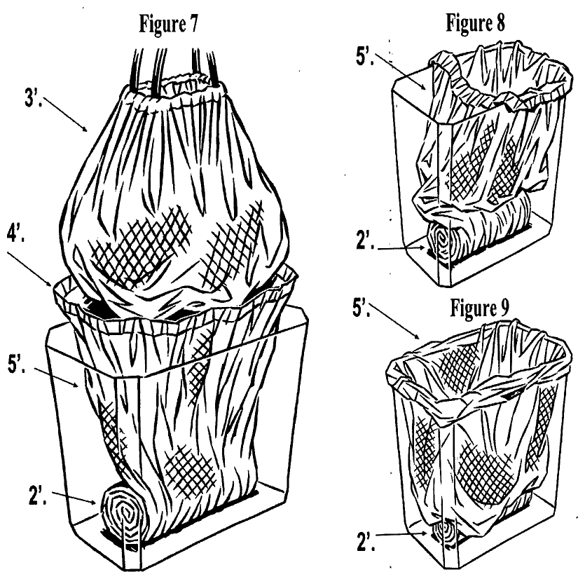

### DETAILED DESCRIPTION OF PREFERRED EMBODIMENTS

The Infinity bag roll 2,2′ is placed at the bottom of the trash bin 1. The first infinity bag 3,3′ is set over trash bin 1.

The full trash bag 3,3′ is unset from trash bin 1.
When the full trash bag 3,3′ is lifted out, the adhesive technology 4,4′ allows the pre nest bag 5 to automatically be brought up. The pre nested bag 5 is brought up from the roll of bags 2,2′ that remain at the bottom of the trash bin 1.

The adhesive technology 4,4′ keeps the full trash bag 3,3′ and the pre nested bag 5 connected until the user performs a light tug to separate both bags.

After the full trash bag 3,3′ is removed from the trash bin 1. The newly provided bag 5 is set around trash bin 1.

This process is repeated from start to finish when the bag 5 is ready to be taken out.

1. Trash bags uniquely rolled and packaged to allow a continuous connection of pre nested trash bags. (2,2′)

2. Single trash bags connecting other trash bags with adhesive technology (4,4′)

3. The trash bag (3,3′) is set within the trash bag below (5) at a distance of ⅓ of the length from the bottom of the previous trash bag (5).

4. Folding bags and rolling them up (2,2′) to allow the bags to remain in bottom of trash bin (1)
